(19) United States
(12) Patent Application Publication
(10) Pub. No.: US 2004/0229487 A1
(43) Pub. Date: Nov. 18, 2004

(54) Electrical conductor connector having a short-circuit bridge

(75) Inventors: Harald Michael Lutsch, Weiterstadt (DE); Rachid Ainceri, Darmstadt (DE)

Correspondence Address: SUGHRUE MION, PLLC, 2100 PENNSYLVANIA AVENUE, N.W., SUITE 800, WASHINGTON, DC, 20037, US

(73) Assignee: YAZAKI EUROPE LTD.

(21) Appl. No.: 10/841,627

(22) Filed: May 10, 2004

(30) Foreign Application Priority Data
May 12, 2003 (DE) 10321420.8

(51) Int. Cl. H01R 29/00

(52) U.S. Cl. 439/188

(57) ABSTRACT

An electrical conductor connector including a first connector element, to which at least two first contact elements are arranged, which, respectively, serve for the electrical connection of a cable or a circuit board. The first connector element forms at least one receptacle, having a flat first support face and parallel thereto a second support face, wherein at least the first support face is partially enclosed by an edge, having two parallel side faces. At least one short-circuit bridge is arranged on the first connector element. The bridge is made from an electrically conducting plate-like material and has a flat first support portion and a second support portion opposed with a distance thereto and integrally connected to the first support portion, wherein both support portions are formed to deform elastically towards each other and abut with a pre-loading the mating support face of the mating receptacle and wherein the first support portion has two opposite side edges, retained between the side faces of the receptacle. The short-circuit bridge has at least two elastic contact arms integrally connected to the second support portion. The connector also includes a second connector element, to which a number of second contact elements, corresponding to the number of first contact elements, is arranged, which are formed fittingly in reference to the first contact elements and, respectively, serve for an electrical conducting connection of a cable or of a conductor plate. The second connector element includes a lifting element. In the not-connected condition of the two connector elements the contact arms are elastically held in contact with the first contact elements and in the connected condition of the same, these are held out off contact to the first contact elements by means of the lifting element, and wherein the first support portion is provided with engagement portions, engaging in one of the faces delimiting the receptacle.

### BACKGROUND OF THE INVENTION

The invention relates to an electrical conductor connector with a short-circuit bridge.

Electrical conductor connectors are, for example, used in a large number in vehicles. In conductor connectors, used in connection with components of the vehicle, in which the danger exists, that an operating error or damage because of static charge can be produced, when the connector elements of the conductor connector are separated from each other, the component-sided connector element is provided with at least one short-circuit bridge, with which, respectively, two contact elements are electrically short-circuited. Therewith, also the circuits connected thereto are short-circuited.

Such an electrical conductor connector with a short-circuit bridge is, for example, described in DE 199 47 029 A1. It comprises a first and a second connector element. The first connector element has several first contact elements, which, respectively, are received in a receiving chamber of the housing of the first connector element and are electrically connected to a cable. It further has a cavity, in which a projection is provided. In this cavity a short-circuit bridge is retained by means of the projection and by means of lugs. The short-circuit bridge is made from an electrically conductive material. It has a flat support portion, having the lugs for the retainment and supported on an outer wall of the receiving chamber. An elastic portion starts from the support portion, which is bent back with a distance towards the support portion by approximately 180° and which extends back towards and passed the support portion. The bent back portion forms two elastic contact arms, serving for, respectively, elastically and electrically contacting a first contact element, when the first connector element is not connected to a second connector element of the conductor connector. The second connector element has one or several detaching projections as lifting elements, serving for lifting the contact arms of the short-circuit bridge from the first connector element, when connecting the two connector elements and therewith, of the second contact elements arranged thereto, with the first contact elements of the first connector element.

The support of the short-circuit bridge in the cavity is achieved on the one hand via the support portion and on the other hand at a distance thereto by the abutment of the elastic portion in the area, in which it is bent back, against the separation wall between the receiving chamber and the cavity, receiving the short-circuit bridge. This causes a relative long and therewith, a structure limited in stiffness, whereby on the one hand the necessary installation space for the insertion of the short-circuit bridge is large and on the other hand the contact pressure of the contact arms is reduced.

### SUMMARY OF THE INVENTION

The invention is based on the object, to provide an electrical conductor connector, in which one of the mating connector elements is provided with a short-circuit bridge, wherein the retaining arrangement for the short-circuit bridge in the connector element and the structure of the short-circuit bridge are adapted to each other such, that short contact arms can be achieved and additionally, a secure retainment at high contact forces is achieved.

This object is solved by an electrical conductor connector comprising a first connector element and a second connector element. The first connector element has at least two first contact elements, which, respectively, serve for the electrical connection of a cable or a circuit board. The first connector element forms at least one receptacle, having a flat first support face and parallel thereto a second support face, wherein at least the first support face is partially enclosed by an edge, having two parallel side faces. At least one short-circuit bridge is arranged on the first connector element. The short-circuit bridge is made from an electrically conducting plate-like material and has a flat first support portion and a second support portion opposed with a distance thereto and integrally connected to the first support portion, wherein both support portions are formed to deform elastically towards each other and abut with a pre-loading the mating support face of the mating receptacle and wherein the first support portion has two opposite side edges, retained between the side faces of the receptacle. The short-circuit element has at least two elastic contact arms integrally connected to the second support portion

The second connector element has a number of second contact elements, corresponding to the number of first contact elements, which are formed fittingly in reference to the first contact elements and, respectively, serve as an electrical conducting connection of a cable or of a conductor plate, and to which a lifting element is arranged. In the not-connected condition of the two connector elements, the contact arms are elastically held in contact with the first contact elements and in the connected condition of the same, these are held out off contact with the first contact elements by means of the lifting element, and wherein the first support portion is provided with engagement portions, engaging in one of the faces delimiting the receptacle.

Of advantage in this embodiment is, that by means of the two-sided retainment of the retaining web in the area of the receptacle, an advantageous support is achieved, so that short contact arms can be realized, which have a high stiffness. The enclosure in the area of the receptacle by means of the two support portions of the short-circuit bridge is especially advantageous, as the two support portions in the area of the receptacle abut the support faces with an area contact and can be brought into abutment thereto with a high pre-loading, so that the means necessary, to secure the short-circuit bridge against the pushing-on direction onto the receptacle, have to absorb no essentially large forces. Therefore, it is possible, to arrange the engagement portions only to the first support portion, wherein the advantage is, that when lifting the contact arms, no forces act having a negative influence on the retainment on the engagement portions.

The short-circuit bridge can be manufactured from a not corroding steel, for example, spring steel, so that the abutment force is also ensured over a long life time.

By means of the possibility, to form the contact arms short, these are correspondingly formed rigidly, so that high contact forces towards the first contact elements can be achieved and, therefore, also under disadvantageous conditions a high contact force is achieved, maintaining a secure electrical connection.

By means of the side faces, furthermore, the short-circuit bridge is, also, secured against rotation in its position in the receptacle. When more than two first contact elements have to be short-circuited, also a short-circuit bridge can be provided, which has a corresponding number of contact arms.

For a first embodiment of the conductor connector according to the invention it is provided, that on the side edges of the first support portion, at least one projection is formed, respectively, as an engagement portion, having in the pushing-on direction a low-gradient flank and opposite the pushing-on direction a steep flank. In this case, it is advantageous, when the steep flank extends perpendicular to the pushing-on direction, so that the resistance against a pushing-out from the receptacle is correspondingly high.

In an embodiment of the conductor connector according to the invention it is provided for a second embodiment, that on both side edges of the first support portion, respectively, at least one triangular projection is formed as an engagement portion, engaging with its projecting tip in the first support face.

A further embodiment of the conductor connector according to the invention provides, that on the first support portion at least one projection is formed as an engagement portion by punching out and bending, projecting in the direction of the second support portion and engaging in the first support face.

For a fourth embodiment of the conductor connector according to the invention it is provided, that the first support portion has a slot-like cut-out, extending parallel to the plugging-on direction and which opposed delimiting edges are provided with projections, projecting towards each other, as engagement portions, and that the first support face is split by a web, arranged in the cut-out and in which corresponding side faces, the engaging portions engage.

In a fifth embodiment of the conductor connector according to the invention it is, further, provided, that the first support portion comprises a portion, formed as a base portion, and a portion, formed as a tongue, which opposite side edges, respectively, are provided with at least one projection as an engagement portion, and that the first support face comprises a first support face portion, adapted to the base portion, and a second support face portion, adapted to the tongue, wherein the tongue engages with its engagement portions in the side faces of the edge, delimiting the second support face portion.

In all embodiments a transition is provided between the first support face and the second support face in form of a rounding and in that the first support portion and the second support portion of the short-circuit bridge are connected by means of an arc portion adapted to the contour of the rounding.

### BRIEF DESCRIPTION OF THE DRAWINGS

Preferred embodiments of the invention are shown schematically in the drawing and are described in detail by means of the same:

FIG. 1 is a longitudinal sectional view of a conductor connector having a first and second connector element before the same are connected to each other;

FIG. 2 illustrates a first embodiment of the short-circuit bridge and the corresponding receptacle in the retaining web before the two are connected to each other;

FIG. 3 illustrates a short-circuit bridge and the receptacle of FIG. 2 in the connected condition;

FIG. 4 illustrates a further embodiment of the short-circuit bridge and the receptacle before the two are connected to each other;

FIG. 5 illustrates the short-circuit bridge shown in FIG. 4 in the connected condition in the receptacle;

FIG. 6 illustrates a third embodiment of the short-circuit bridge and the receptacle of the retaining web before the two are connected to each other;

FIG. 7 illustrates the short-circuit bridge of FIG. 6 in the connected condition with the receptacle;

FIG. 8 illustrates a fourth embodiment of a short-circuit bridge and the receptacle of the retaining web for the same before connecting;

FIG. 9 illustrates the short-circuit bridge of FIG. 8 in the connected condition with the corresponding (mating) receptacle of the retaining web;

FIG. 10 illustrates a fifth embodiment of a short-circuit bridge and a corresponding receptacle of the retaining web before connecting; and

FIG. 11 illustrates the short-circuit bridge of FIG. 10 in the connected condition with the corresponding receptacle.

### DETAILED DESCRIPTION OF THE INVENTION

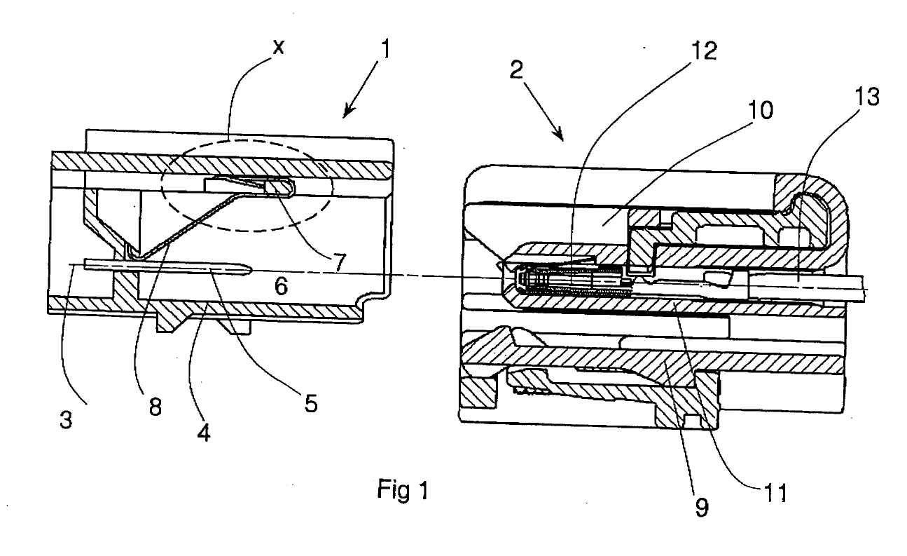

The conductor connector shown in FIG. 1 comprises a first connector element 1 and a second connector element 2, shown centered on a longitudinal axis 3, on which they are moved towards each other to be connected to each other. The first connector element 1 has a first connector housing 4, enclosing a receiving chamber 6, into which the second connector element 2 enters when being connected. Through the base of the connector housing 4 a number of first contact elements 5 for example, in form of contact pins, project parallel to the longitudinal axis, of which only one is shown. The others can be arranged in several rows in reference to the drawing plane above each other and arranged distanced to each other into the drawing plane. However, at least two first contact elements 5 are provided, of which the second contact element is arranged in a plane behind the paper plane and behind the represented first contact element 5. The contact element 5 projects through the base of the first connector housing 4 and is, for example, inserted on the side facing away from the receiving chamber 6 into a device and is, for example, there connected to a circuit board or cables. The first connector housing 4 may have, for example, a flange, with which it is mounted on the corresponding housing of the device or the component of the vehicle.

In the receiving chamber 6 a retaining web 7 is arranged passing the receiving chamber 6 and forming at least one receptacle, on which a short-circuit bridge 8 is retained. The short-circuit bridge 8 short-circuits by means of contact arms, contacting in an electrically conducting manner the first contact elements 5, when the two connector elements 1, 2 are not connected to each other. The design of the short-circuit bridge 8 in different embodiments (variants) and the arrangement to the retaining web 7 are described in detail by means of the detail X, shown in the further Figures for these embodiments (variants). On the longitudinal axis 3 the second connector element 2 is, also, shown centered. It comprises a second connector housing 9, having a corresponding number of receiving chambers 10 to the number of first contact elements 5, extending parallel to the longitudinal axis 3 and which receive respectively, one second contact element 12. The receiving chamber 10 is split up by means of separation walls 11. The second contact elements 12, of which only one of the first contact elements 5 is represented in an opposed manner, are, respectively, electrically connected to a cable 13, which is extended from the second connector housing 9. Furthermore, the second connector housing 9 has a lifting element 14, serving for lifting the contact arms of the short-circuit bridge 8 off the first contact element 5, when connecting the two connector elements 1, 2, so that, when further connecting the two contact elements 5, 12 electrically contact each other and the short-circuiting is cancelled. This is, also, valid for the further pair of contact elements 5, 12, which is off-set to the visibly represented pair of contact elements 5, 12 with a distance from the drawing plane, so that the short-circuiting connection between the two first contact elements 5 is cancelled.

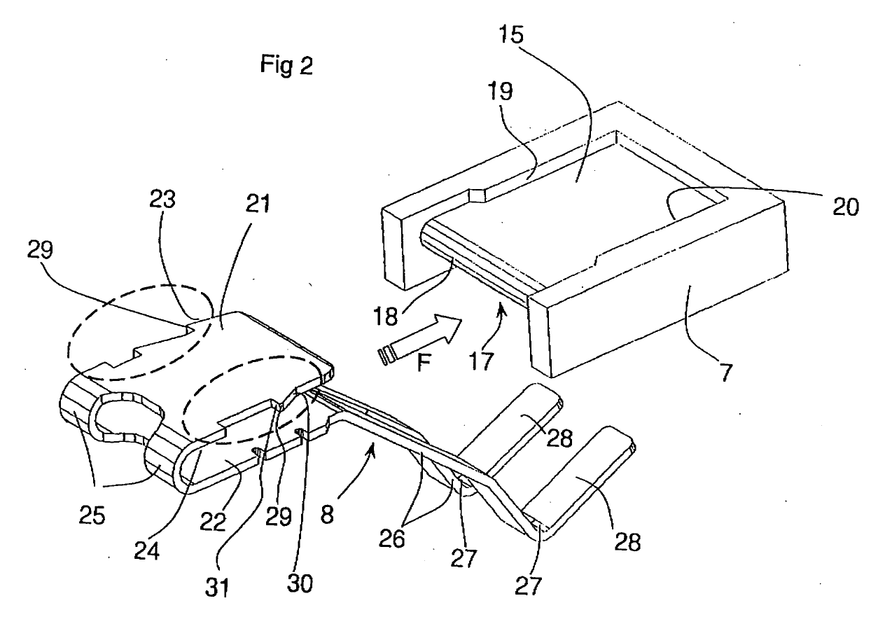

In reference to the structure of the short-circuit bridge and the portions of the retaining web 7 receiving and fixing the same, are described in detail by means of FIGS. 2 to 11, representing the detail X for in total five embodiments.

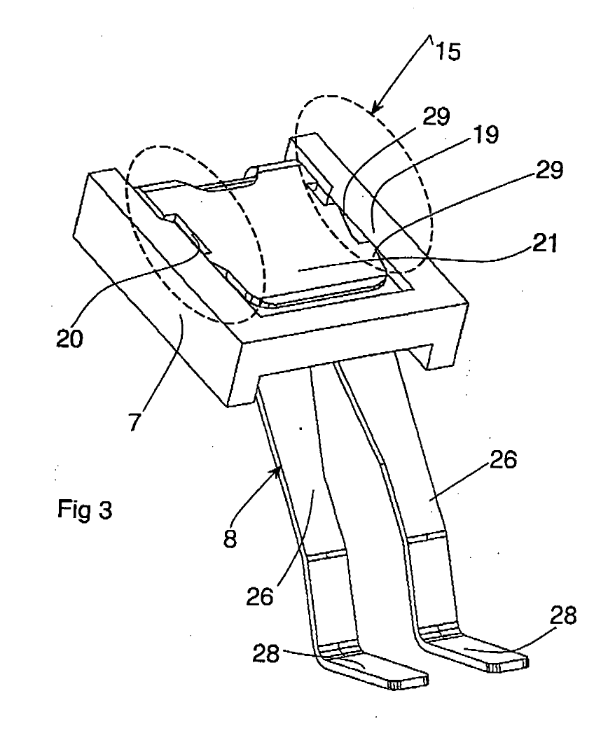

In the following a first embodiment is described in detail by means of FIGS. 2 and 3. The further four embodiments are, respectively, described by means of the following drawings, wherein the portions and components of the further four embodiments are, respectively, characterized by reference numerals, differing from each other by the numerical value 100.

In the embodiment of FIGS. 2 and 3 in the retaining web 7 a receptacle 15 is provided for the short-circuit bridge 8, comprising a first flat support face 16 and a second support face 17 arranged parallel thereto, connected by means of a rounding 18 to each other. The receptacle 15 comprises a further rim, forming the first side face 19 and a second side face 20, extending parallel to each other and delimiting laterally the first support face 16.

The short-circuit bridge 8 is made from an electrically conductive plate-like material and comprises an essentially flat first support portion 21 and a second support portion 22, arranged parallel to the first support portion 21, wherein the two support portions 21, 22 are arranged opposed to each other and are arranged with a distance to each other and are connected integrally to each other by an arc portion 25. The first support portion 21 has a first side edge 23 and a second side edge 24, arranged opposite thereto, wherein on the two side edges 23, 24 engagement portions 29 in form of projections are formed, which have in the pushing-on direction F onto the receptacle 15 at the front, a low-gradient flank 30 and at the rear, a steep flank 31, wherein the steep flank 31 extends perpendicular to the pushing-on direction F.

The second support portion 22 is followed by two contact arms 26 integrally connected thereto, which are bent relative to the second support portion 22, furthermore, in their further extension are again bent and end in lifting portions 28 bent thereto. In the bending area towards the lifting portion 28 contact zones 27 are formed, which contact the corresponding first contact elements.

The mounted condition represented in FIG. 3 is achieved such, that the short-circuit bridge 8 is pushed onto the retaining web 7 in the area of the receptacle 15, so that the first support portion 21 comes to rest on the first support face 16 and the second support portion 22 on the second support face 17 and come into close contact with these because of the elastic effect and the pre-loading. The arc portion 25 is adapted to the rounding 18. At the same time, when pushing-on in the direction F, the engagement portions 29 are pressed into the material of the side faces 19, 20, i.e. the engagement portions 29 in form of the projections cut into the material of the retaining web 7 and engage in this. An elastic form fitting is achieved, as the first connector housing is made from an electrically insulating plastic material, which is softer than the material, from which the short-circuit bridge 8 is made. Furthermore, the short-circuit bridge 8 is secured by the side edges 23, 24 in connection with the side faces 19, 20 of the receptacle 15 against a lateral or rotational displacement.

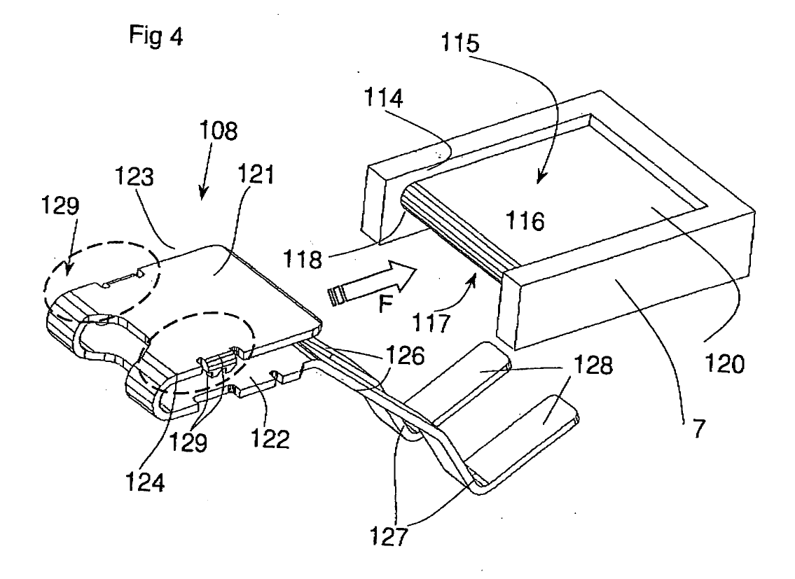

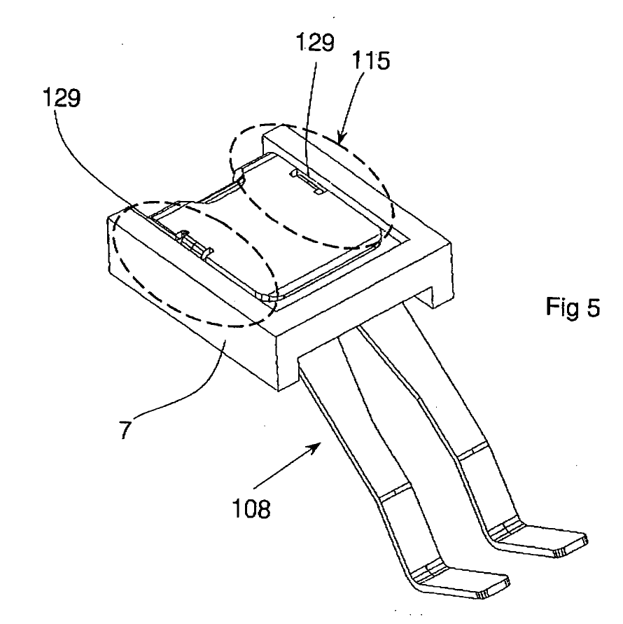

FIGS. 4 and 5 show a second embodiment in form of the short-circuit bridge 108 and the receptacle 115. Here, components, which correspond to each other, are provided with reference numerals, which are increased by the numerical value 100 compared to the first embodiment of FIGS. 2 and 3, so that for their description it is referred to the corresponding description of FIGS. 2 and 3.

In the following the differences are described in detail.

In difference to the embodiment of FIGS. 2 and 3, in the area of the side edges 123, 124 of the first support portion 121 of the short-circuit bridge 108, engagement projections 129 are punched out, so that a triangular form is formed and is bent in the direction towards the second support portion 122, so that the tips of the engagement portions 129 are arranged opposed to the second support portion 122. When pushing-on the two support portions 121, 122 of the short-circuit bridge 108 onto the receptacle 115, the second support portion 122 is supported on the not visible second support face 117,-while because of the spring force, the engagement projections 129 engage in the first support face 116 and secure the short-circuit bridge 108 against a movement opposite to the pushing-on direction F on the retaining web 7 in the area of the receptacle 115. The side faces 119, 120 secure, hereby, the short-circuit bridge 108 or especially the first support portion 121 against lateral displacement and rotation.

The connected condition is shown in FIG. 5.

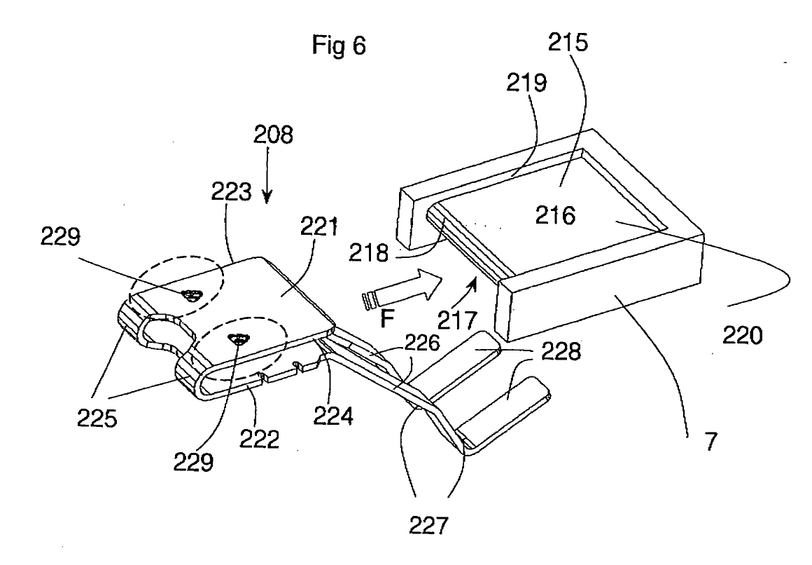

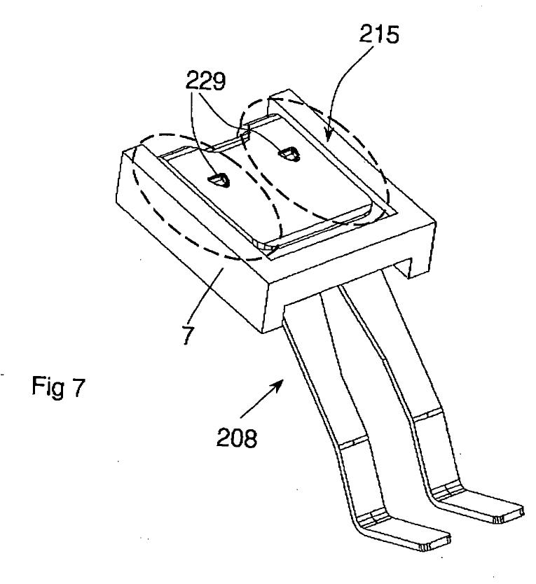

FIGS. 6 and 7 show a third embodiment of the short-circuit bridge 208 and the receptacle 215, wherein the components or portions of the same, which correspond to those of the first embodiment of FIGS. 2 and 3, are provided with reference numerals, increased by the numerical value 200 compared to those of FIGS. 2 and 3. For their description it is referred to the corresponding description of FIGS. 2 and 3.

In the embodiment of FIGS. 6 and 7 the receptacle 215 corresponds practically to the receptacle 115, as described in connection with FIGS. 4 and 5. At the short-circuit bridge 208, two engagement portions 229, having a triangular form, are punched out in the support portion 221, so that a connection is still maintained on one side edge and bent backwards, so that the ends of these triangular projections face in the direction towards the second support portion 222. As in the embodiment of FIGS. 4 and 5 the engagement projections 229 engage, also, in this embodiment of FIGS. 6 and 7 in the mounted condition, as it is shown in FIG. 7, in the first support face 216, so that a retainment against displacement opposite the pushing-on direction F is achieved.

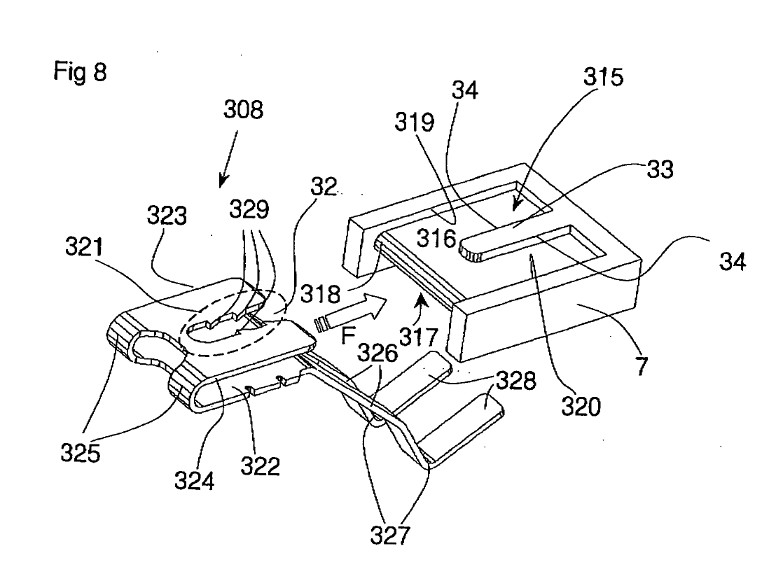

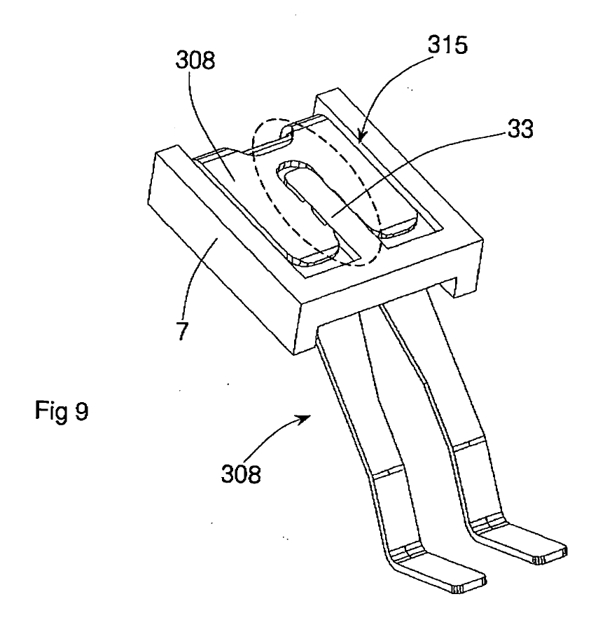

FIGS. 8 and 9 show a fourth embodiment of the structure of a short-circuit bridge 308 and of a receptacle 315 in the retaining web 7, wherein portions or elements of the same, which correspond to those of the first embodiment of FIGS. 2 and 3, are provided with reference numerals, which are increased by the numerical value 300 to those of FIGS. 2 and 3, so that in reference to their description it is referred to the description of FIGS. 2 and 3. In difference to the embodiment of FIGS. 2 and 3, in the area of the first support face 316, a web 33 is provided, which splits this support face 316. The two opposite side faces 34 of the web interact with the engagement projections 329, arranged in the area of the opposingly arranged side edges of a cut-out 32 of the first support portion 321 of the short-circuit bridge 308. The engagement projections 329 are correspondingly formed to those of FIGS. 2 and 3. When pushing-on the short-circuit bridge 308 with its two support portions 321, 322 onto the receptacle 315 of the retaining web 7, the web 33 comes to rest in the cut-out 32 and the engagement projections 329 engage in side faces 34 of the web 33, which facing away from each other, and secure this in the same way, as described in connection with the embodiment of FIGS. 2 and 3.

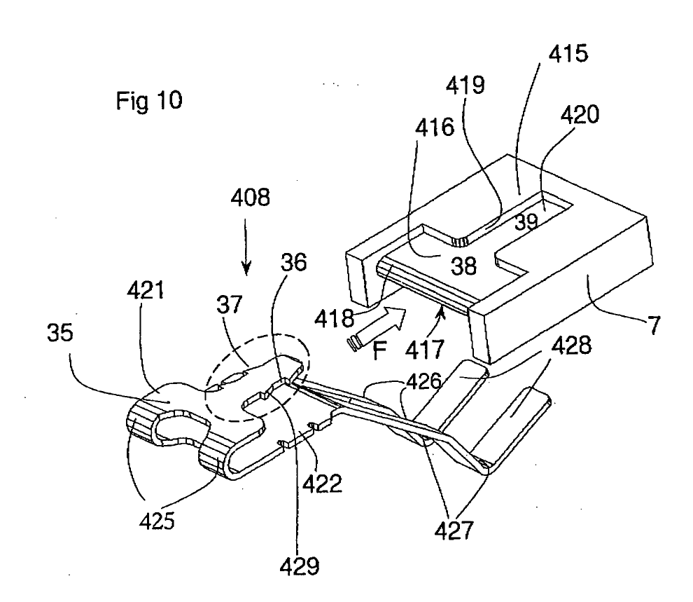

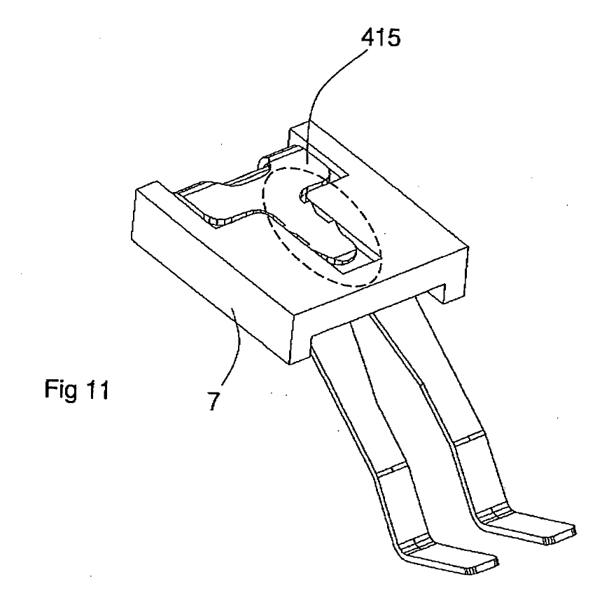

A fifth embodiment for a short-circuit bridge 408 and a receptacle 415 of the retaining web 7 meant therefore are explained by using FIGS. 10 and 11. Here, only the portions and elements, which are formed differently to those of the first embodiment of FIGS. 2 and 3, are described. Same components and elements, which are already described in connection with the embodiment of FIGS. 2 and 3, are provided with reference numerals, which are increased by the numerical value 400 compared to those of FIGS. 2 and 3. Concerning their description it is referred to the description of FIGS. 2 and 3.

Different to the embodiment of FIGS. 2 and 3, the first support portion 421 is separated into two portions. It comprises the base portion 35 and a tongue 36, projecting therefrom, wherein the two side edges 37 of the tongue 36, which are facing away from each other, are provided with engagement projections 429, which correspond to those described in connection with FIGS. 2 and 3. In the mounted condition, i.e. in the condition of being pushed onto the receptacle 415 in the arrow direction F, the base portion 35 of the first support portion 421 rests on the first support face portion 38 of the first support face 416 and the tongue 36 rests on the second support face portion 39 of the first support face 416, wherein the engagement portions 429 engage in the two side faces 419, 420, delimiting laterally the receptacle 415 in the area of the second support face portion 39. This portion is adapted to the shape of the tongue 36.

What is claimed is:

1. Electrical conductor connector comprising:
a first connector element,
to which at least two first contact elements are arranged, which, respectively, serve for the electrical connection of a cable or a circuit board,
which forms at least one receptacle, having a flat first support face and parallel thereto a second support face, wherein at least the first support face is partially enclosed by an edge, having two parallel side faces, and
to which at least one short-circuit bridge is arranged,
which is made from an electrically conducting plate-like material and has a flat first support portion and a second support portion opposed with a distance thereto and integrally connected to the first support portion, wherein both support portions are formed to deform elastically towards each other and abut with a pre-loading the mating support face of the mating receptacle and wherein the first support portion has two opposite side edges, retained between the side faces of the receptacle and
which has at least two elastic contact arms integrally connected to the second support portion, and a second connector element,
to which a number of second contact elements, corresponding to the number of first contact elements, is arranged, which are formed fittingly in reference to the first contact elements and, respectively, serve for an electrical conducting connection of a cable or of a conductor plate, and to which
a lifting element is arranged,
wherein in the not-connected condition of the two connector elements, the contact arms are elastically held in contact with the first contact elements and in the connected condition of the same, these are held out off contact to the first contact elements by means of the lifting element, and wherein the first support portion is provided with engagement portions, engaging in one of the faces delimiting the receptacle.

2. Conductor connector according to claim 1, wherein on the side edges of the first support portion, at least one projection is, respectively, provided as an engagement portion, having in the insertion direction a low-gradient flank and opposite to the plugging-on direction a steep flank.

3. Conductor connector according to claim 2, wherein the steep flank extends perpendicular to the plugging-on direction.

4. Conductor connector according to claim 1, wherein on both side edges of the first support portion, respectively, at least one triangular projection is formed as an engagement portion, engaging with its projecting tip in the first support face.

5. Conductor connector according to claim 1, wherein on the first support portion at least one projection is formed as an engagement portion by means of punching and bending, which projection projecting in the direction of the second support portion and engaging in the first support face.

6. Conductor connector according to claim 1, wherein the first support portion has a slot-like cut-out, extending parallel to the plugging-on direction (F) and which opposed delimiting edges are provided with projections, projecting towards each other, as engagement portions, and that the first support face is split by a web, arranged in the cut-out and in which corresponding side faces, the engaging portions engage.

7. Conductor connector according to claim 1, wherein the first support portion comprises a portion formed as a base portion and a portion formed as a tongue, which opposite side edges, respectively, are provided with at least one projection as an engagement portion, and that the first support face comprises a first support face portion, adapted to the base portion, and a second support face portion adapted to the tongue, wherein the tongue engages with its engagement portions in the side faces of the edge, delimiting the second support face portion.

8. Conductor connector according to claim 1, wherein a transition is provided between the first support face and the second support face in form of a rounding and in that the first support portion and the second support portion of the short-circuit bridge are connected by an arc portion adapted to the contour of the rounding.
